(19) United States
(12) Patent Application Publication
(10) Pub. No.: US 2008/0020091 A1
(43) Pub. Date: Jan. 24, 2008

(54) Method For Producing Bread Or Similar Oven-Baked Articles

(76) Inventor: Angelo Pietro Rossin, Vigevano (IT)

Correspondence Address: LADAS & PARRY, 5670 WILSHIRE BOULEVARD, SUITE 2100, LOS ANGELES, CA, 90036-5679, US

(21) Appl. No.: 11/579,402

(22) PCT Filed: May 5, 2005
(86) PCT No.: PCT/IB05/53038

§ 371 Date: Jan. 22, 2007

(30) Foreign Application Priority Data
May 12, 2004 (IT) MI2004A 000957

(51) Int. Cl. B65D 81/34; A21D 15/00; A21D 15/02; A21D 8/06

(52) U.S. Cl. 426/19; 426/113; 426/393

(57) ABSTRACT

A method for producing bread or similar oven-baked articles, comprising: a stage in which the bread mix is prepared, a stage of splitting the mix and dividing it into a plurality of dough parts, and a stage of leavening said parts, and comprising subsequent to said stages a further stage of pre-baking said leavened parts, a subsequent stage of cooling said pre-baked parts, a subsequent stage of deep-freezing said cooled parts, and a subsequent stage of packaging predefined quantities of said deep-frozen parts in a plastic container resistant to heat and at least partially permeable to gases.

The present invention relates to a method for producing bread or similar oven-baked articles, a package for the bread or the oven-baked articles produced by said method, and the system for implementing said method, in accordance with the pre-characterising part of the independent claims.

In the present context, the term “oven-baked articles” means any product containing flour and yeast which requires baking in an oven, such as: pizza bases or cakes in general, focaccias, salted or sweet croissants, savoury biscuits, pizza biscuits, pasties, bread rolls, pastry slices such as strudel or plaits.

It is known to bake bread, deep-freeze it and market it deep-frozen. The deep-frozen bread is generally marketed in containers from which it is extracted to heat it in an oven before being eaten or sold. The bread obtained in this manner does not always present characteristics of freshness and satisfactory taste for the consumer. Moreover the operations required to transfer the deep-frozen bread from the containers in which it is usually marketed to the oven are sometimes difficult or at least not easy.

An object of the present invention is to provide a method for producing bread and similar oven-baked articles which overcomes the aforestated drawbacks and, in particular, enables bread to be produced with optimal freshness and taste qualities, and which simplifies and facilitates the final bread baking stage.

An object of the present invention is also to provide a container for the bread or similar oven-baked articles produced by the aforesaid method, which simplifies and facilitates the transfer of the pre-baked and deep-frozen bread into the-oven for the final bread baking stage.

An object of the present invention is also to provide a system for producing bread or similar oven-baked articles able to produce bread with optimal freshness and taste qualities and which simplifies and facilitates the final bread baking stage.

These and further objects which will be apparent to an expert of the art are attained by a method, a container, and a system in accordance with the pre-characterising part of the accompanying claims.

A particular embodiment of the invention is described hereinafter by way of non-limiting example.

The method for producing bread or similar oven-baked articles according to the invention comprises a usual first stage in which the bread mix is prepared, a usual second stage of splitting the mix and dividing it into parts, and a conventional stage of leavening said parts. Preferably the leavening process is completely natural. According to the invention, the leavened parts of the mix are then subjected to a pre-baking stage, then a stage of cooling said pre-baked parts, then a stage of deep-freezing said cooled parts, and finally a stage of packaging predefined quantities of said deep-frozen parts in a plastic container which is heat resistant and at least partially permeable to gases. In this manner the purchaser of the pre-baked and deep-frozen bread can then effect final baking of the product by placing the container containing the various pieces of deep-frozen and pre-baked bread into the oven without having to extract them from the container. As the pre-baked and deep-frozen bread is distributed to the final bread producers packaged in plastic containers, the operations involved in loading and unloading the oven are simplified and accelerated. Moreover, as the plastic containers can act as the sole packaging for distributing the pre-baked and deep-frozen bread, this can have beneficial effects both on packaging and distribution costs and on the quantity of material required to form said packages.

It should also be noted that the final bread baking stage is preferably carried out in a place different and separate from that in which the mixing, splitting, leavening, pre-baking, deep-freezing and packaging stages are carried out. In other words, the pre-baked, deep-frozen and packaged bread is generally produced and sold as an intermediate product for production of bread, this however being effectively produced by the purchaser of the pre-baked, deep-frozen and packaged bread, by effecting final baking of the deep-frozen bread in the container itself.

According to the invention, the predefined quantities of packaged deep-frozen parts are inserted into containers in the form of a bag, i.e. into a usual flexible container of substantially tubular form closed at its bottom and at its top. This container is constructed of a plastic material at least partially permeable to gases and/or presents a plurality of small-dimension holes to enable the steam to escape during final bread baking.

Advantageously the pre-baking stage comprises baking to the extent of between about 70% and 90% of the total baking necessary for producing the bread, conducted at a temperature between 100° C. and 250° C., for a time between 10 and 40 minutes. Preferably, pieces of mix between 30 and 150 grams are pre-baked at 195° C. for 15 minutes, to achieve baking to the extent of about 80/85% of total bread baking.

It should be noted that in the present context, pre-baking means bread baking of the type indicated in the preceding two paragraphs.

Preferably after pre-baking, the cooling stage takes place at ambient temperature, in order to accompany the product to the subsequent deep-freezing stage without it undergoing violent thermal shocks which could compromise bread quality.

Deep-freezing is of the rapid forced type and takes place by maintaining the pre-baked and cooled dough parts at a temperature less than or equal to −35° C. for a time greater than or equal to 10 minutes. Deep-freezing preferably takes place at −40° C. for 15 minutes.

Preferably the pre-baked and deep-frozen bread is not subjected to stabilizing treatments to accelerate or delay its development.

Advantageously, prior to the deep-freezing stage a plurality of dough parts are disposed on a tray, the trays are then loaded onto a tray-carrying trolley, said trolleys being pushed into a deep-freezing cell for the deep-freezing stage. The tray-carrying trolleys are made to enter the deep-freezing cell through a first opening and made to leave through a second opening to enable the trolleys to be inserted into said cell in series, to accelerate and rationalize the deep-freezing stage.

The containers with the pre-baked and deep-frozen bread are stored at a temperature less than or equal to −20° C.

It should be noted that the method of the invention has proved particularly suitable for producing bread or oven-baked articles of relatively small dimensions and weight, for example of weight between 20 and 200 grams.

The system of devices required for implementing the aforedescribed method results from a combination of devices all of known type and which will therefore not be described in detail hereinafter. This system comprises: usual means for producing a bread mix, usual means for splitting the mix into a plurality of dough parts and their possible automatic loading onto usual oven trays to be automatically or manually loaded onto relative trolleys, means for leavening said parts, usual means for pre-baking said leavened parts, means a enabling said pre-baked parts to be cooled, means for deep-freezing said cooled parts, and means for packaging said measured quantities of said deep-frozen parts in a plastic container which is heat resistant and at least partially permeable to gases, to enable a final user to effect final bread baking together with said container. The plastic container is preferably a perforated bag, the packaging means in this case comprising a hopper containing the pre-baked and deep-frozen dough pieces and a usual device for loading predefined quantities of said pre-baked deep-frozen dough parts into bags. These are formed in conventional manner starting from a continuous tubular plastic web or from a plastic sheet folded and welded longitudinally to obtain a continuous tube. To obtain the bags these tubular elements, after receiving the predefined quantities of deep-frozen and pre-baked dough pieces, are cut at predefined distances and closed upperly and lowerly.

Advantageously, the deep-freezing means comprise a deep-freezing cell enabling the trolleys to enter through a first entry opening and to leave through a second opening to enable the trolleys to be inserted into said cell in series.

The system also comprises means for storing the containers of deep-frozen dough pieces at a temperature less than or equal to −20° C.

To produce the containers for the pre-baked and deep-frozen dough pieces any plastic material for food use can be used which resists the aforesaid temperature range between at least −40° C. and +250° C. for heating times of at least 40 minutes at +250° C., and is at least partially permeable to gases, to enable the steam generated during final bread baking to leave. A material of the aforestated type is for example that marketed under the brand name “Lumirror 10.23” of Toray Plastic Europe SA.

Finally it should be noted that the invention has been described with reference to one embodiment, to which numerous variants and modifications can be provided, all falling within the same inventive concept.

1. A method for producing bread or similar oven-baked articles, comprising: a stage in which the bread mix is prepared, a stage of splitting the mix and dividing it into a plurality of dough parts, and a stage of leavening said parts, characterised by comprising subsequent to said stages a further stage of pre-baking said leavened parts, a subsequent stage of cooling said pre-baked parts, a subsequent stage of deep-freezing said cooled parts, and a subsequent stage of packaging predefined quantities of said deep-frozen parts in a plastic container resistant to heat and at least partially permeable to gases.

2. A method as claimed in claim 1, characterised in that said predefined quantities of deep-frozen parts are baked in an oven together with the container in which they are contained, so as to complete their baking and produce the bread to be consumed.

3. A method as claimed in claim 1, characterised in that the pre-baked and deep-frozen product is distributed to final bread users in heat resistant plastic containers.

4. A method as claimed in claim 3, characterised in that the plastic containers are able to act as the sole packaging for distributing the deep-frozen product.

5. A method as claimed in claim 2, characterised in that the final baking stage is effected in a place different and separate from that in which the mixing, splitting, leavening, pre-baking, deep-freezing and packaging stages take place.

6. A method as claimed in claim 1, characterised in that the pre-baking stage comprises baking to the extent of between about 70% and 90% of the total baking necessary for producing the bread.

7. A method as claimed in claim 1, characterised in that the pre-baking stage takes place at a temperature between 100° C. and 250° C., for a time between 10 and 40 minutes.

8. A method as claimed in claim 1, characterised in that the cooling takes place at ambient temperature.

9. A method as claimed in claim 1, characterised in that the deep-freezing is of forced rapid type.

10. A method as claimed in claim 9, characterised in that the deep-freezing takes place by maintaining the pre-baked and cooled dough parts at a temperature less than or equal to −35° C. for a time greater than or equal to 10 minutes.

11. A method as claimed in claim 1, characterised in that prior to the deep-freezing stage a plurality of dough parts are disposed on a tray, a plurality of trays being loaded onto a tray-carrying trolley, said trolleys being pushed into a deep-freezing cell for the deep-freezing stage.

12. A method as claimed in claim 11, characterised in that the tray-carrying trolleys are made to enter the deep-freezing cell through a first opening and made to leave through a second opening to enable the trolleys to be inserted into said cell in series

13. A method as claimed in claim 1, characterised by packaging the predetermined quantities of deep-frozen products in bags.

14. A method as claimed in claim 1, characterised by storing the containers of deep-frozen dough pieces at a temperature less than or equal to −20° C.

15. A method as claimed in claim 1, characterised by producing bread portions having a weight between 20 and 200 grams.

16. Packaging for bread or similar oven-baked articles, in which the bread or said oven-baked articles are of pre-baked deep-frozen type, characterised by comprising a plastic container resistant to heat and at least partially permeable to gases, and able to contain a plurality of pre-baked and deep-frozen bread portions, to enable final baking of the bread to take place together with said container.

17. Packaging as claimed in claim 16, characterised in that the heat resistant container is able to be used as packaging for distribution to the final bread producers.

18. Packaging as claimed in claim 16, characterised in that the plastic containers can act as sole packaging for distributing the bread to the final producers.

19. Packaging as claimed in claim 16, characterised in that the plastic containers are able to be deep-frozen and to withstand-a-temperature less than or equal to −35° C. for a time greater than or equal to 10 minutes.

20. Packaging as claimed in claim 16, characterised in that the plastic containers are bags.

21. Packaging as claimed in claim 20, characterised in that the bags comprise a plurality of holes enabling the steam to escape during final baking of the bread pieces.

22. A system for producing bread or similar oven-baked articles, comprising: means for producing a bread mix, means for splitting the mix and dividing the mix into a plurality of dough parts and means for leavening said parts, characterised by comprising means for pre-baking said leavened parts, means enabling said pre-baked parts to be cooled, means for deep-freezing said cooled parts, and means for automatically packaging measured quantities of said deep-frozen parts in a plastic container which is heat resistant and at least partially permeable to gases, to enable a final user to effect final bread baking together with said container.

23. A system as claimed in claim 22, characterised in that the packaging means are arranged to form said containers starting from a continuous tubular plastic web.

24. A system for producing bread or similar oven-baked articles as claimed in claim 22, characterised in that the deep-freezing means are of the type for achieving rapid forced deep-freezing.

25. A system for producing bread or similar oven-baked articles as claimed in claim 22, characterised by comprising a plurality of trays to receive a plurality of dough parts and a plurality of trolleys for carrying said trays.

26. A system for producing bread or similar oven-baked articles as claimed in claim 24, characterised in that the deep-freezing means comprise a deep-freezing cell enabling the trolleys to enter through a first entry opening and to leave through a second opening to hence enable the trolleys to be inserted into said cell in series.

27. A system for producing bread or similar oven-baked articles as claimed in claim 22, characterised in that the packaging means are of the type able to package measured quantities of deep-frozen parts in bags.

28. A system for producing bread or similar oven-baked articles as claimed in claim 22, characterised by comprising means for storing the containers of deep-frozen dough parts at a temperature less than or equal to −20° C.

29. A system for producing bread or similar oven-baked articles as claimed in claim 22, characterised in that the means for dividing the mix into a plurality of parts are of the type able to divide said mix into portions having a weight between 20 and 200 grams.
